(19) United States
(12) Patent Application Publication
(10) Pub. No.: US 2023/0310236 A1
(43) Pub. Date: Oct. 5, 2023

(54) VEHICLE

(71) Applicant: Wally SALVAN, Saint-Clement (FR)

(72) Inventor: Wally SALVAN, Saint-Clement (FR)

(21) Appl. No.: 18/024,426

(22) PCT Filed: Sep. 3, 2021
(86) PCT No.: PCT/EP2021/074379

§ 371 Date: Mar. 2, 2023

(30) Foreign Application Priority Data
Sep. 4, 2020 (FR) FR2009021

(51) Int. Cl. A61G 5/10

(52) U.S. Cl. CPC A61G 5/1083

(57) ABSTRACT

This vehicle (2) usable by a physically handicapped or able-bodied person, in particular for athletic or recreational activities, comprises a seat (4) made from monobloc plastic material and at least two main wheels (6), the seat (4) comprising a seat bottom (40), a backrest (42) and lateral rims (43). The seat (4) has a cavity (18) extending below the backrest (42) and the seat bottom (40) and an opening passing through the seat (4) between the cavity (18) and a rear part of the backrest (42), the cavity (18) and the opening being intended to accommodate a backrest of a seat (4) of a second identical vehicle positioned below said vehicle (2), such that at least two identical vehicles (2) are stacked stably one on top of the other.

The present invention relates to a vehicle usable by a physically handicapped or able-bodied person, in particular for athletic or recreational activities.

Leisure chairs for physically handicapped persons who for example move in a wheelchair are generally cumbersome products that are difficult to stow for storage or transport. Vehicles, for example such as wheelchairs, with a structure particularly suited to playing a sport such as basketball, rugby, tennis or a water sport, known from EP 2,498,741, include a rotomolded seat and removable wheels. Such wheelchairs have a significant footprint, such that in order to store or transport wheelchairs for an entire group sports team, considerable floor space is needed.

The invention aims to address these drawbacks by proposing a new vehicle making it possible to optimize the floorspace necessary for storage or transport.

To that end, the invention relates to a vehicle usable by a physically handicapped or able-bodied person, in particular for athletic or recreational activities, comprising a seat made from monobloc plastic material and at least two main wheels, the seat comprising a seat bottom, a backrest and lateral rims. This vehicle is characterized in that the seat has a cavity extending below the backrest and the seat bottom and an opening passing through the seat between the cavity and a rear part of the backrest, the cavity and the opening being intended to accommodate a backrest of a seat of a second identical vehicle positioned below said vehicle, such that at least two identical vehicles are stacked stably one on top of the other.

Owing to the invention, at least two vehicles can be stacked stably, which allows a significant reduction in the floorspace occupied by a set of vehicles, and therefore allows them to be stowed vertically in a storage space or in a transport vehicle.

According to advantageous but optional aspects, such a vehicle may incorporate one or more of the following features, considered alone or according to any technically allowable combination:
The cavity comprises a curved surface oriented downward and the shape of which is complementary to the curved shape of an upper edge of the lateral rims, and in the stacked configuration of two respective upper and lower vehicles, the two curved surfaces of the upper vehicle rest on the upper edges of the lateral rims of the seat of the lower vehicle.
The seat has, behind the backrest, a rounded storage space for the main wheels in a disassembled configuration.
The backrest includes at least one through hole having a flat, and the vehicle comprises a screw passing through said at least one hole and a hub of the main wheels in the disassembled configuration placed in the storage space, and keeping the main wheels in the disassembled configuration fixed in the storage space.
The vehicle comprises further front casters and rear casters, which allow the vehicle to move on the ground when the main wheels are in a disassembled configuration.
The main wheels are moveable between:
   a mounted rolling configuration, where each main wheel rotates around a respective central axis relative to the vehicle, the vehicle being configured to rest on the ground via the main wheels, et
   a transport configuration, where each main wheel is moved away from the corresponding seat, according to a translation movement parallel to the corresponding central axis,
wherein, when two or more vehicles are stacked on top of each other in a stable manner, the main wheels of these vehicles being in the transport configuration, the main wheels of the vehicle located above the other provide with the corresponding seat a receiving space for the main wheels of the vehicle located below the other.
The vehicle comprises further front casters and rear casters, wherein, when two or more identical vehicles are stacked on top of each other in a stable manner, the front and rear casters of the lowest vehicle allow the stack of vehicles to move on the ground.

The invention will be better understood and other advantages thereof will appear more clearly in light of the following description of one embodiment of a vehicle provided solely as a non-limiting example and done in reference to the appended drawings, in which:

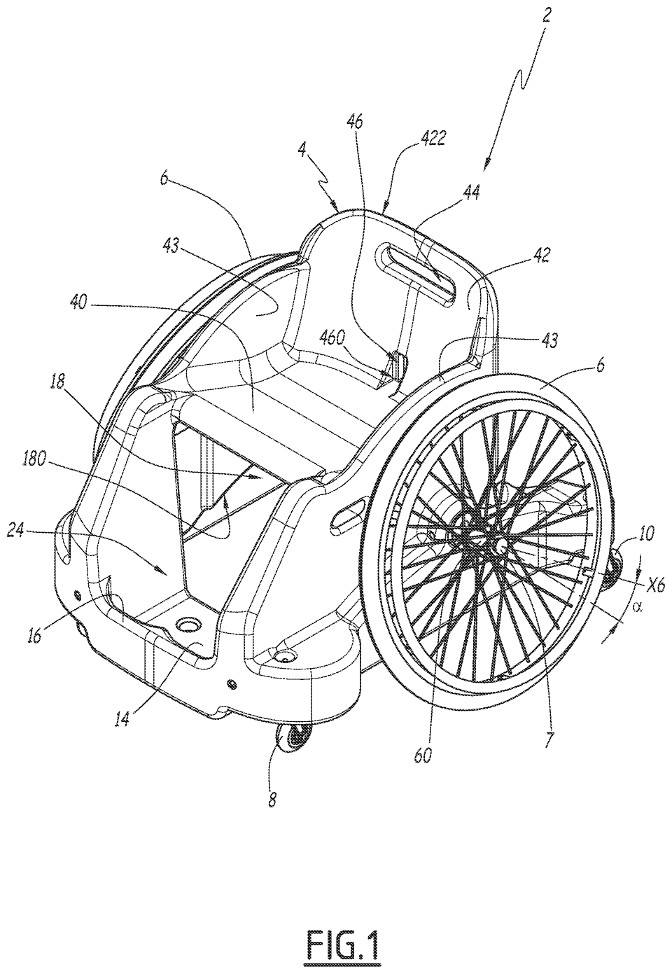

FIG. 1 is a perspective view of a vehicle according to the invention, comprising main wheels in a mounted rolling configuration;

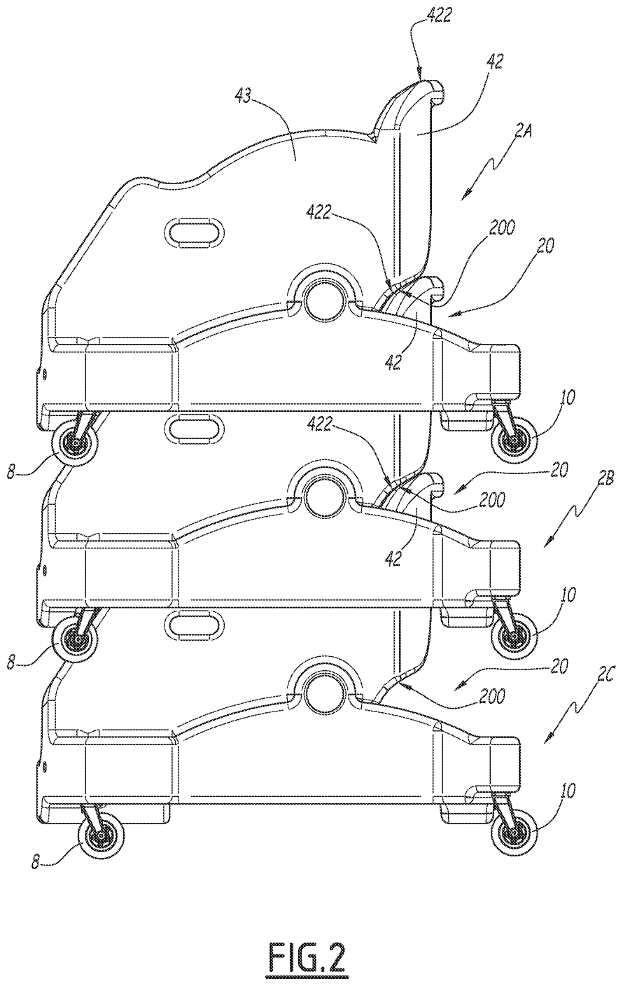

FIG. 2 is a side view of three vehicles, similar to that of FIG. 1, stacked, and the main wheels of which are disassembled;

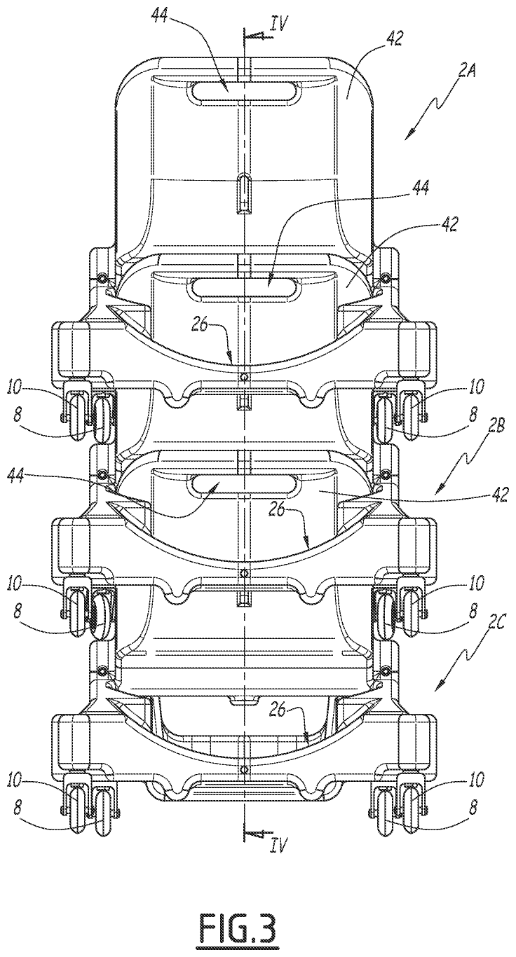

FIG. 3 is a rear view of the three vehicles of FIG. 2;

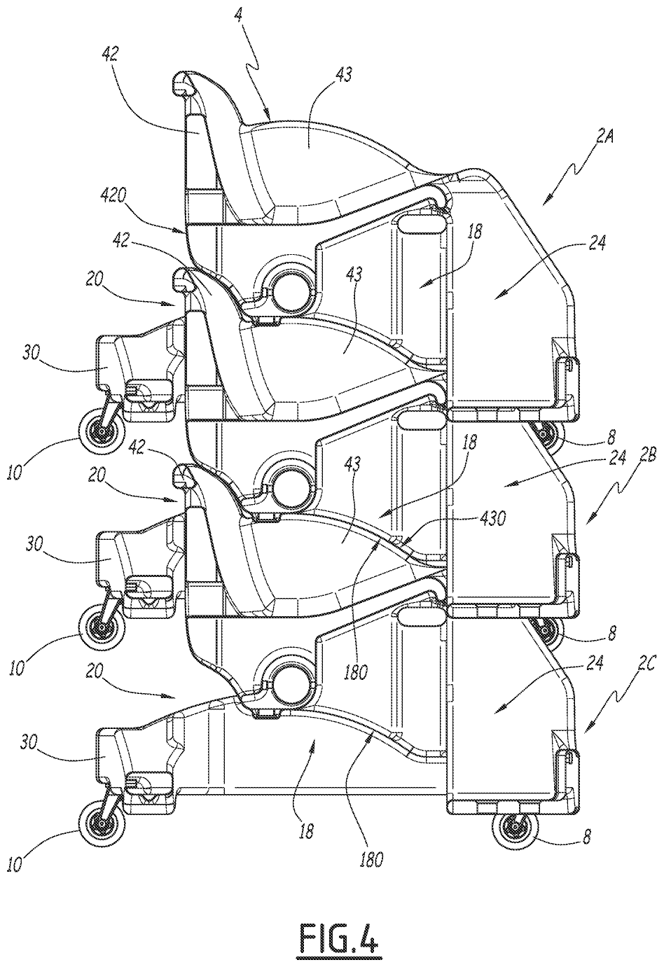

FIG. 4 is a sectional view along median plane IV of the three vehicles of FIGS. 2 and 3;

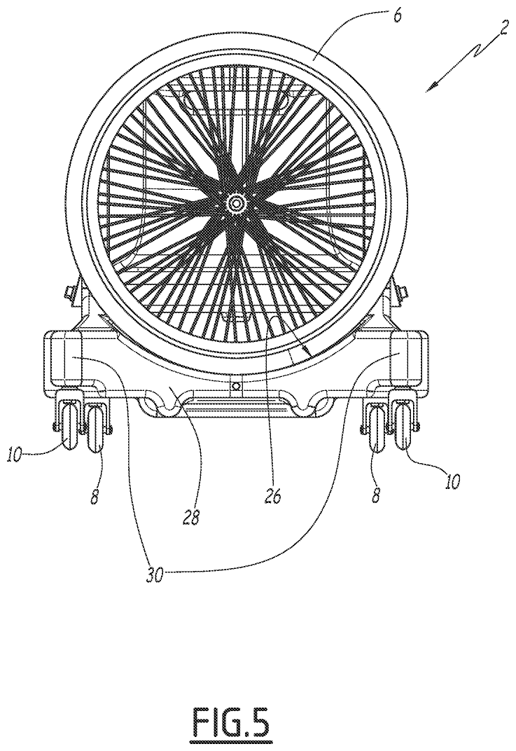

FIG. 5 is a rear view of the vehicle of FIG. 1, two main wheels of which are disassembled and stowed in a rear space;

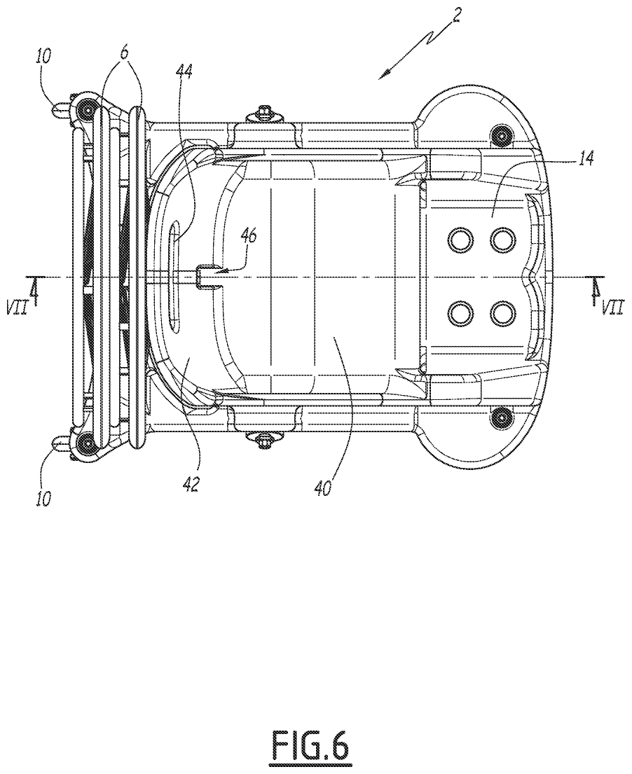

FIG. 6 is a top view of the vehicle of FIG. 5;

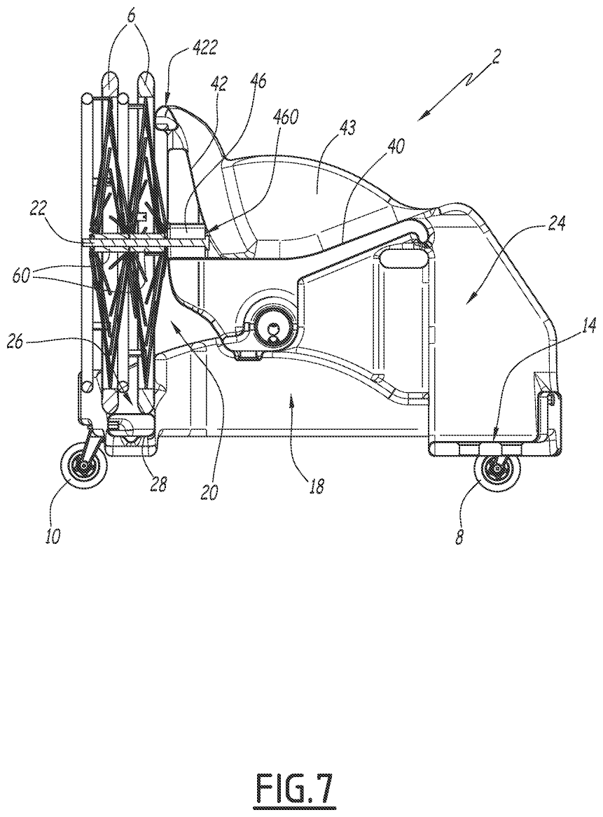

FIG. 7 is a sectional view along median plane VII of the vehicle of FIG. 5;

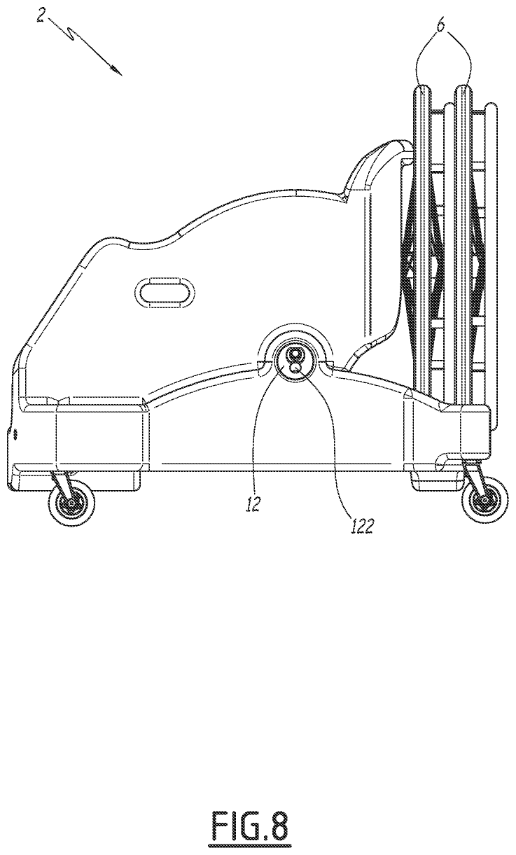

FIG. 8 is a side view of the vehicle of FIG. 5, equipped with main wheels of large diameter stowed in the rear space;

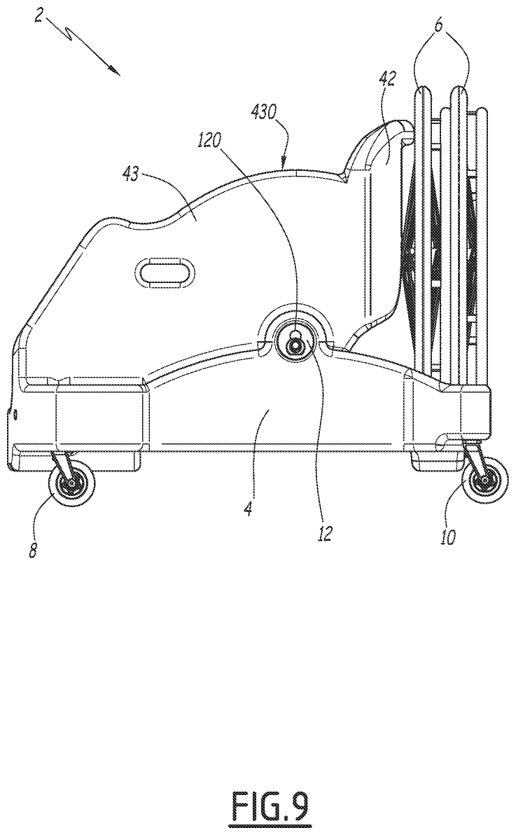

FIG. 9 is a side view of the vehicle of FIG. 5, equipped with main wheels of reduced diameter stowed in the rear space, and

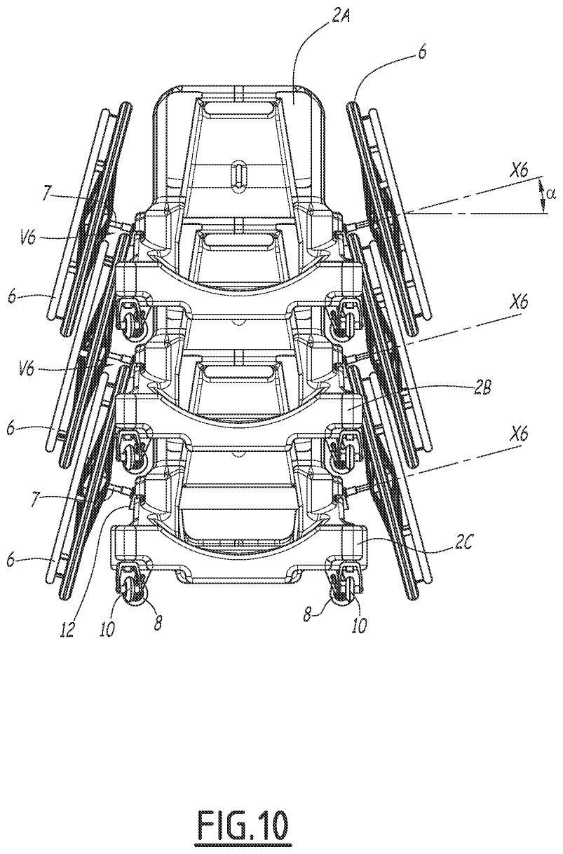

FIG. 10 is a rear view of three vehicles, similar to the one in FIG. 1, stacked and with the main wheels in a transport configuration.

The vehicle 2, as shown in FIG. 1, of the wheelchair type, is usable by a physically handicapped or able-bodied person, in particular for athletic or recreational activities. This vehicle 2 comprises a seat 4 for a user, the seat 4 comprising a seat bottom 40, a backrest 42, and lateral rims 43 arranged on either side of the seat bottom 40.

The backrest 42 includes a transverse opening forming a handle 44.

The seat 4, made from plastic, is made in a single block. The seat 4 is for example made by a method of the rotational molding type. The seat 4 can be made in series of different measurements. Sizes of seats can for example be made based on different sizes of wheels, for example 22 inches, 24 inches or 26 inches.

Optionally, a heating device, for example an electrical resistance, can be integrated into the seat 4. By using a seat 4 made from thermoformable polymer, this heating device makes it possible to produce a seat 4 adapted to each user by heating the seat beforehand, which then conforms to the morphology of the user.

In the present disclosure, certain parts of the vehicle 2 are designated as being behind or in front of or above or below the vehicle 2, or on the lateral sides of the vehicle 2, these indications corresponding to a flat position of the vehicle 2 in which the user, bearing on the seat bottom 40 and the backrest 42, is facing forward. However, these positions of the vehicle 2 and the user are not limiting. The vehicle 2 can for example backup of tilt sideways. The user can for example lean or rotate his torso.

The vehicle 2 comprises two main wheels 6, shown in FIG. 1 in an assembled rolling configuration, in which central axes X6 of rotation of the main wheels 6 are inclined relative to the ground. Each central axis X6 is inclined with respect to the horizontal, forming a camber angle α. In particular, the camber angle α contributes to the stability of the vehicle 2 when moving over the ground. The main wheels 6 have hubs 60 that are hollow and intended to be mounted on an axle, not shown, that passes through the seat 4 below the seat bottom 40. Each main wheel 6 is here mounted to the seat 4 by means of a respective rod 7. Each rod 7 has an elongated shape, which extends along a respective central axis X6 when the corresponding main wheel 6 is in the mounted rolling configuration.

The vehicle 2 comprises wheel supports 12 that are mounted in orifices of the lateral rims 43 and connected with the axle. Each wheel support 12 comprises an upper orifice 120 and a lower orifice 122, the upper orifice 120 being intended to assemble main wheels 6 larger in size than the main wheels 6 intended to be mounted on the lower orifices 122. For example, 24 inch wheels can be mounted on the upper orifices 120, and 22 inch wheels on the lower orifices 122. When the vehicle 2 is equipped with two main wheels 6 in mounted rolling configuration, these two wheels 6 have the same size.

In the mounted rolling configuration, the hub 60 of each main wheel 6 has a respective rod 7 passing through it, this rod 7 cooperating with the corresponding wheel support 12. Each rod 7 is thus partly received in one of the upper 120 or lower 122 orifice of the corresponding wheel support 12. Each wheel support 12 is provided with a locking device, not shown, configured to block the translational movements of the rod 7 with respect to the wheel support 12 parallel to the corresponding central axis X6, so as to maintain the corresponding main wheel 6 in a mounted rolling configuration. Each rod 7 is then in a so-called “forward” position. Each locking device is reversible, so as to allow the removal of the main wheels 6, as explained later. Each rod 7 is here a quick-clip axle, which cooperates with the corresponding wheel support 12 for easy assembly and disassembly.

The seat 4 comprises a low platform 14, on which the feet of a user are intended to rest. The low platform 14 comprises a peripheral rim 16 delimiting a protected space. The feet of the user are advantageously kept in this protected space.

The vehicle 2 comprises at least one front movement member, for example comprising two front casters 8. The vehicle 2 also comprises at least one rear movement member, for example comprising two rear casters 10. The rear casters 10 have an anti-tipping function. The rear casters 10 are for example arranged in a position behind the seat 4 and at a determined height such that they stay above the ground, when the main wheels 6 are in the mounted rolling configuration, that is to say when the vehicle 2 is rolling on a flat surface bearing on its front casters 8 and on its main wheels 6.

More generally, when the main wheels 6 are in the mounted rolling configuration, the front 8 and rear 10 casters contribute to the stability of the vehicle 2.

As illustrated in FIGS. 2 through 9, the main wheels 6 of the vehicle 2 are removable. When a main wheel 6 is removed, the corresponding rod 7 is fully extended from the corresponding wheel support 12.

When the main wheels 6 of the vehicle 2 are in the disassembled configuration, the front casters 8 and the rear casters 10 allow the vehicle 2 to move on the ground. Preferably, the front casters 8 and the rear casters 10 are located in the same geometric plane, so that when the vehicle 2 moves on a flat surface, all the front casters 8 and the rear casters 10 rest on this surface.

The seat 4 has a cavity 18 extending below the backrest 42 and the seat bottom 40, and an opening 20 passing through the seat 4 between the cavity 18 and a rear part 420 of the backrest 42. The cavity 18 and the opening 20 form a receiving volume making it possible to accommodate a backrest of a seat of a second identical vehicle positioned below said vehicle, such that said vehicle and the second vehicle are stacked stably one on top of the other. “Stably” means that these two identical vehicles thus stacked or piled remain immobile relative to one another, at least in translation parallel to the ground or in rotation perpendicular to the ground.

It is thus possible to stack, or pile, at least two identical vehicles 2 one on top of the other, or even three or more, and to save substantial floorspace. The cavity 18 also extends forward by an opening 24 delimited in the upper part by the seat bottom 40, on the sides by the lateral rims 43 and in the lower part by the low platform 14.

FIGS. 2, 3 and 4 show three identical vehicles 2A, 2B and 2C stacked or piled on top of one another along a vertical direction in order to form a stack. Thus, in the stacked configuration, the three vehicles 2A, 2B and 2C only take up the floorspace of a single vehicle 2.

When two or more identical vehicles 2 are stacked on top of each other in a stable manner, forming a stack of vehicles 2, the front 8 and rear 10 casters of the lowest vehicle 2 allow the stack of vehicles 2 to move on the ground.

The cavity 18 of the seat 4 of the vehicle 2B makes it possible to accommodate the lateral rims 43 of the seat 4 of the lower vehicle 2C, and the opening 20 of the seat 4 of the vehicle 2B makes it possible to accommodate the backrest 42 of the seat 4 of the lower vehicle 2C. The cavity 18 comprises a curved surface 180 oriented downward and the shape of which is complementary to the curved shape of the upper edge 430 of the lateral rims 43. The curved surface 180 delimits, toward the bottom of the seat 4, a widening of the width, along the lateral direction perpendicular to the front-back direction, of the cavity 18, making it possible to accommodate the lateral rims 43 of the seat 4 of the lower vehicle 2C. Thus in the stacked or piled position, the two curved surfaces 180 of the upper vehicle 2B rest on the upper edges 430 of the lateral rims 43 of the seat 4 of the lower vehicle 2C. The same is true for the vehicles 2A and 2B, the vehicle 2B then in this case becoming the lower vehicle.

The opening 20 allows the insertion of the backrest 42 of the lower vehicle 2C such that the latter is encompassed in the volume defined by the seat 4 of the upper vehicle 2B, the height of the two stacked or piled vehicles 2B and 2C being less than the total added heights of these two vehicles.

Seen from the side like in FIG. 2, the opening 20 has a curved shape 200 that is complementary to the shape of an upper edge 422 of the backrest 42. In the piled or stacked configuration, the lower part of the backrest 42 of the upper vehicle 2B therefore rests on the upper edge 422 of the backrest 42 of the lower vehicle 2C. The same is true for the vehicles 2A and 2B.

In the stacked or piled configuration, the front 8 and rear 10 casters of the vehicle 2C located the lowest allow the movement on the ground of the stack of vehicles 2A, 2B and 2C.

The main wheels 6 can be disassembled for the transport or storage of the vehicles 2 and when the vehicles 2 are stacked or piled, the main wheels 6 are disassembled. In order to allow the storage of the main wheels 6, the seat 4 has, behind the backrest 42, a rounded storage area 26 for the main wheels 6 in a disassembled configuration. This storage space 26 assumes the form of an arc of circle-shaped surface, the central axis of which is oriented along the front-back direction of the vehicle 2. The storage space 26 is provided on a rear platform 28 of the seat 4, which extends along the lateral direction of the seat 4. The rear platform 28 is supported by two lateral protuberances 30 oriented along the front-back direction, integral with the seat 4, and which also support the rear casters 10.

The diameter of the storage space 26 allows main wheels to be stowed therein having a diameter of 24 inches (FIG. 8) or a diameter of 22 inches (FIG. 9). The main wheels 6 are placed parallel to one another with the rolling surface in contact with the arc of circle-shaped surface forming the storage space 26. The central axis of the main wheels 6 in the stowed configuration is parallel to the central axis of the storage space 26.

The backrest 42 includes a through hole 46 oriented along the front-back direction. This hole 46 can be used to discharge water present on the seat bottom 40. The hole 46 has a flat 460, for example located on the front side. The vehicle 2 comprises a screw 22 passing through the hole 46 and the hubs 60 of the main wheels 6 in the disassembled configuration and placed in the storage space 26. A nut, not shown, is screwed on the screw 22 in order to keep the main wheels 6 in the disassembled configuration fixed in the storage space 26.

In a variant that is not shown, the seat 4 can comprise two separate holes making it possible to fix each of the two main wheels 6 independently.

Three stacked vehicles 2A, 2B and 2C are shown in FIG. 10. The main wheels 6 of these vehicles 2 are each in a so-called “transport” configuration, in which each rod 7 is still partially received in the corresponding wheel support 12, in a so-called “backward” position. In the transport configuration, each main wheel 6 is further away from the seat 4 than in the mounted rolling configuration, while still being connected, via the rod 7, to the rest of the vehicle 2. In other words, a main wheel 6 in the transport configuration is moved away from the corresponding seat 4, according to a translation movement parallel to the corresponding central axis X6.

A travel of the rod 7 between the forward and backward positions, as well as the camber angle α, are chosen so that, on the one hand, in the transport configuration, the main wheels 6 of the lowest vehicle 2, here the vehicle 2C, do not touch the ground when this lowest vehicle 2 rests on its front 8 and rear 10 casters, and, on the other hand, for the other vehicles 2A and 2B stacked on the lowest vehicle 2, each main wheel 6 in transport configuration leaves, between this main wheel 6 and the corresponding seat 4, a receiving space V6 for receiving a main wheel 6 in transport configuration belonging to the vehicle 2 located immediately below.

In other words, when the main wheels 6 of a vehicle 2 are in the transport configuration, the front casters 8 and the rear casters 10 allow this vehicle 2 to move on the ground. When two vehicles 2 in transport configuration are stacked on top of each other in a stable manner, the main wheels 6 of the vehicle 2 located above the other provide with the corresponding seat 4 a receiving space V6 for the main wheels 6 of the vehicle 2 located below the other, while the front casters 8 and the rear casters 10 of the lower vehicle 2 allow the stack of vehicles 2 to move on the ground.

When storing the vehicles 2, it is thus possible to stack the vehicles 2 without having to completely remove the main wheels 6. As each rod 7 remains engaged in the corresponding upper or lower orifice 120 or 122, it is particularly easy, when putting the vehicles 2 back into service, to switch each main wheel 6 from its transport configuration to its mounted rolling configuration.

The travel of the rod 7 and the camber angle α are chosen according to the size of the main wheels 6 and the size of the seat 4. In practice, the travel of the rod 7 is between 50 and 120 mm, while the camber angle α is between 0° and 22°, preferably between 5° and 20°. In the illustrated example, the travel of the rod 7 is equal to 120 mm, while the camber angle α is equal to 15°.

The locking device of each wheel support 12 advantageously comprises an indexing system, which indicates to the user that the rod 7 reaches its backward position, when said user moves this main wheel 6 from its mounted rolling configuration to its transport configuration.

This fixing mode of the main wheels 6 makes it possible to prevent a user from having to provide additional baggage to transport them.

1. A vehicle usable by a physically handicapped or able-bodied person, in particular for athletic or recreational activities, comprising a seat made from monobloc plastic material and at least two main wheels, the seat comprising a seat bottom, a backrest and lateral rims, wherein the seat has a cavity extending below the backrest and the seat bottom and an opening passing through the seat between the cavity and a rear part of the backrest, the cavity and the opening being intended to accommodate a backrest of a seat of a second identical vehicle positioned below said vehicle, such that at least two identical vehicles are stacked stably one on top of the other.

2. The vehicle according to claim 1, wherein the cavity comprises a curved surface oriented downward and the shape of which is complementary to the curved shape of an upper edge of the lateral rims, and in the stacked configuration of two respective upper and lower vehicles, the two curved surfaces of the upper vehicle rest on the upper edges of the lateral rims of the seat of the lower vehicle.

3. The vehicle according to claim 1, wherein the seat has, behind the backrest, a rounded storage space for the main wheels in a disassembled configuration.

4. The vehicle according to claim 3, wherein the backrest includes at least one through hole having a flat, and in that the vehicle comprises a screw passing through said at least one hole and a hub of the main wheels in the disassembled configuration placed in the storage space, and keeping the main wheels in the disassembled configuration fixed in the storage space.

5. The vehicle according to claim 1, comprising further front casters and rear casters, which allow the vehicle to move on the ground when the main wheels are in a disassembled configuration.

6. The vehicle according to claim 1, wherein the main wheels are moveable between:
a mounted rolling configuration, where each main wheel rotates around a respective central axis relative to the vehicle, the vehicle being configured to rest on the ground via the main wheels, et
a transport configuration, where each main wheel is moved away from the corresponding seat, according to a translation movement parallel to the corresponding central axis,
and wherein, when two or more vehicles are stacked on top of each other in a stable manner, the main wheels of these vehicles being in the transport configuration, the main wheels of the vehicle located above the other provide with the corresponding seat a receiving space for the main wheels of the vehicle located below the other.

7. The vehicle according to claim 6, comprising further front casters and rear casters, wherein, when two or more identical vehicles are stacked on top of each other in a stable manner, the front and rear casters of the lowest vehicle allow the stack of vehicles to move on the ground.
